(19) United States
(12) Patent Application Publication
(10) Pub. No.: US 2023/0410788 A1
(43) Pub. Date: Dec. 21, 2023

(54) METHOD FOR PROVIDING GROUP CALL SERVICE, AND ELECTRONIC DEVICE SUPPORTING SAME

(71) Applicant: Samsung Electronics Co., Ltd., Suwon-si (KR)

(72) Inventors: Mihyang KIM, Suwon-si (KR); Gangyoul KIM, Suwon-si (KR); Taebin KIM, Suwon-si (KR); Yuhoon LEE, Suwon-si (KR); Kitae KIM, Suwon-si (KR); Mooyeol KIM, Suwon-si (KR); Choonho KIM, Suwon-si (KR)

(21) Appl. No.: 18/241,126

(22) Filed: Aug. 31, 2023

Related U.S. Application Data
(63) Continuation of application No. PCT/KR2022/000453, filed on Jan. 11, 2022.

(30) Foreign Application Priority Data
Mar. 2, 2021 (KR) 10-2021-0027314

(51) Int. Cl. G10L 13/033; G10L 15/18; G10L 15/22; G10L 13/04

(52) U.S. Cl. CPC G10L 13/0335; G10L 15/18; G10L 2013/021; G10L 13/04; G10L 15/22

(57) ABSTRACT

An electronic device includes a communication module and a processor operatively connected to the communication module. The processor is configured to: receive and store a first speech voice related to at least a first external device, and a second speech voice related to a second external device; if individual speech is detected, transmit the first speech voice or the second speech voice having a first playback speed to at least a first external device and a second external device; and, if simultaneous speech is detected, convert, into a second playback speed different from the first playback speed, at least a part of a synthesized voice in which at least first overlap speech of the first speech voice and at least second overlap speech of the second speech voice are successively connected, and transmit the synthesized voice to the at least first external device and the second external device.

### CROSS-REFERENCE TO RELATED APPLICATION(S)

This application is a continuation application, claiming priority under § 365(c), of International Application No. PCT/KR2022/000453, filed on Jan. 11, 2022, which is based on and claims the benefit of Korean patent application number 10-2021-0027314 filed on Mar. 2, 2021, in the Korean Intellectual Property Office, the disclosures of which are incorporated by reference herein in their entireties.

### TECHNICAL FIELD

Various embodiments disclosed in the disclosure relate to an electronic device, and specifically, to a method for providing a group call service and an electronic device supporting the same.

### BACKGROUND ART

With recent developments of digital technology, various electronic devices capable of communicating and processing personal information while moving with a mobile communication terminal, an electronic notebook, a smart phone, a tablet PC, a laptop PC, and a wearable device have been released. Such electronic devices have been equipped with various functions such as a video call, an electronic notebook function, a document function, an e-mail function, and an Internet function from simple voice call and short message transmission functions via a rapid technological development.

In one recent example, an electronic device provides a group call service that allows at least two people to talk over the phone simultaneously. The group call service is used for people in different places to promote friendship via the voice or video call or for business purposes such as a remote video conference.

### DISCLOSURE

### Technical Problem

In an operation of the above-mentioned conventional group call service, an electronic device may obtain an uttered voice of a speaker and transmit the uttered voice to an electronic device of another speaker participating in the group call or receive an uttered voice of another speaker.

However, when simultaneous utterances in which at least two speakers speak substantially simultaneously occurs, uttered voices of the simultaneously speaking speakers may overlap each other and be transmitted. In such process, portions of the uttered voices of the simultaneously speaking speakers may be lost.

Accordingly, at least one example of various embodiments provides a method for providing a group call service and an electronic device supporting the same that generate a synthesized voice in which uttered voices of simultaneously speaking speakers are continuously connected to each other and transmit the synthesized voice when simultaneous utterances occur.

### Technical Solution

An electronic device according to various embodiments includes a communication module, and a processor operatively connected to the communication module, and the processor receives and stores a first uttered voice related to at least a first external device and a second uttered voice related to a second external device, transmits the first uttered voice or the second uttered voice having a first reproduction speed to at least the first external device and the second external device when a single utterance is sensed based on the first uttered voice and the second uttered voice, and converts a reproduction speed of at least a portion of a synthesized voice where at least a first overlapping utterance of the first uttered voice and at least a second overlapping utterance of the second uttered voice are continuously connected to each other to a second reproduction speed different from the first reproduction speed and transfers the synthesized voice to at least the first external device and the second external device when simultaneous utterances are sensed based on the first uttered voice and the second uttered voice.

A method for operating an electronic device according to various embodiments may include receiving and storing a first uttered voice related to at least a first external device and a second uttered voice related to a second external device, sensing a single utterance or simultaneous utterances based on the first uttered voice and the second uttered voice, transmitting the first uttered voice or the second uttered voice having a first reproduction speed to at least the first external device and the second external device when the single utterance is sensed, and converting a reproduction speed of at least a portion of a synthesized voice where at least a first overlapping utterance of the first uttered voice and at least a second overlapping utterance of the second uttered voice are continuously connected to each other to a second reproduction speed different from the first reproduction speed and transferring the synthesized voice to at least the first external device and the second external device when the simultaneous utterances are sensed.

An electronic device according to various embodiments may include a communication module, a microphone, an output module, and a processor operatively connected to the communication module, the microphone, and the output module, and the processor may transmit an uttered voice obtained via the microphone to at least a first counterpart communication device and a second counterpart communication device, receive a first uttered voice obtained by the first counterpart communication device and a second uttered voice obtained by the second counterpart communication device, sense a single utterance or simultaneous utterances based on the received first uttered voice and the second uttered voice, output the first uttered voice or the second uttered voice having a first reproduction speed via the output module when the single utterance is sensed, and generate a synthesized voice where at least a first overlapping utterance of the first uttered voice and at least a second overlapping utterance of the second uttered voice are continuously connected to each other and output the synthesized voice at a second reproduction speed different from the first reproduction speed when the simultaneous utterances are sensed.

### Advantageous Effects

When simultaneous utterances occur while providing the group call service, the electronic device according to various embodiments disclosed in the disclosure may generate and transmit the synthesized voice in which the uttered voices of the simultaneously speaking speakers are continuously connected to each other, thereby supporting the uttered voices of the respective simultaneously speaking speakers to be transferred clearly without overlapping each other.

Effects obtainable from the disclosure are not limited to the effects mentioned above.

### DESCRIPTION OF DRAWINGS

FIG. 1 is a block diagram of an electronic device in a network environment according to various embodiments.

FIG. 2A is a diagram schematically showing a configuration of a group call system according to various embodiments.

FIG. 2B is a diagram schematically showing a configuration of an external device according to various embodiments.

FIG. 3A is a diagram for illustrating an operation of obtaining (or extracting) overlapping utterances in an external device according to various embodiments.

FIG. 3B is a diagram illustrating an operation of generating a synthesized voice in an external device according to various embodiments.

FIG. 3C is a diagram for illustrating an operation of reproducing a synthesized voice in an external device according to various embodiments.

FIGS. 3D and 3E are diagrams illustrating an operation of generating a synthesized voice in an external device according to various embodiments.

FIG. 3F is a diagram illustrating natural language processing (NLP) for a synthesized voice in an external device according to various embodiments.

FIG. 4 is a flowchart illustrating an operation of providing a group call service in an electronic device according to various embodiments.

FIG. 5 is a flowchart illustrating an operation of obtaining overlapping utterances in an electronic device according to various embodiments.

FIG. 6 is a flowchart illustrating another operation of obtaining overlapping utterances in an electronic device according to various embodiments.

FIG. 7 is a flowchart illustrating an operation of determining an utterance speed of a synthesized voice in an electronic device according to various embodiments.

FIG. 8 is a diagram illustrating an operation of a group call system according to various embodiments.

FIGS. 9A and 9B are diagrams showing another operation of a group call system according to various embodiments.

FIG. 10 is a diagram illustrating another operation of a group call system according to various embodiments.

FIG. 11 is a collection of diagrams for illustrating a parameter setting operation of a synthesized voice according to various embodiments.

FIG. 12 is a flow diagram illustrating an electronic device operating method according to various embodiments.

In connection with the description of the drawings, the same or similar reference numerals may be used for the same or similar elements.

### MODE FOR INVENTION

Hereinafter, various embodiments of the disclosure will be described with reference to the accompanying drawings. However, this is not intended to limit the disclosure to specific embodiments, and it should be understood to include various modifications, equivalents, and/or alternatives of embodiments of the disclosure.

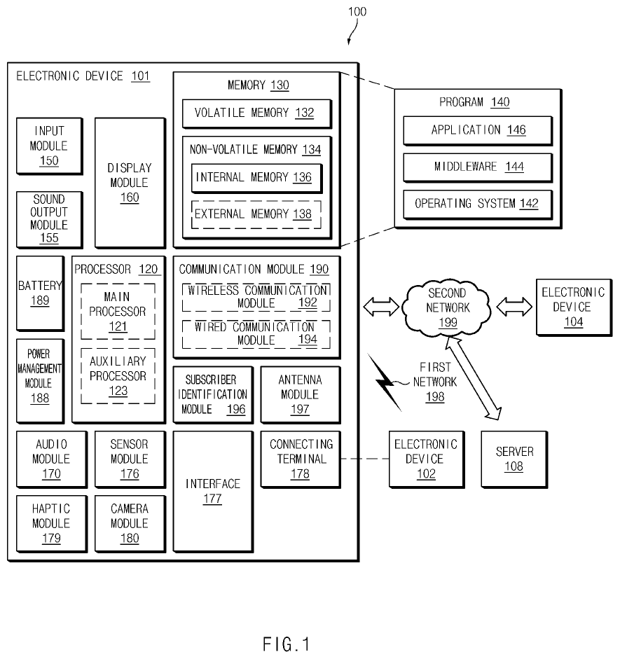

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

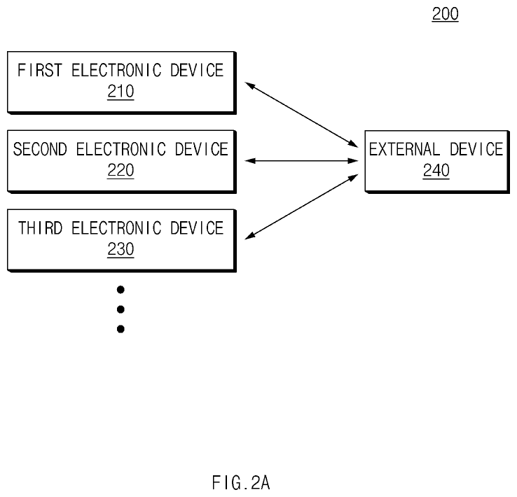

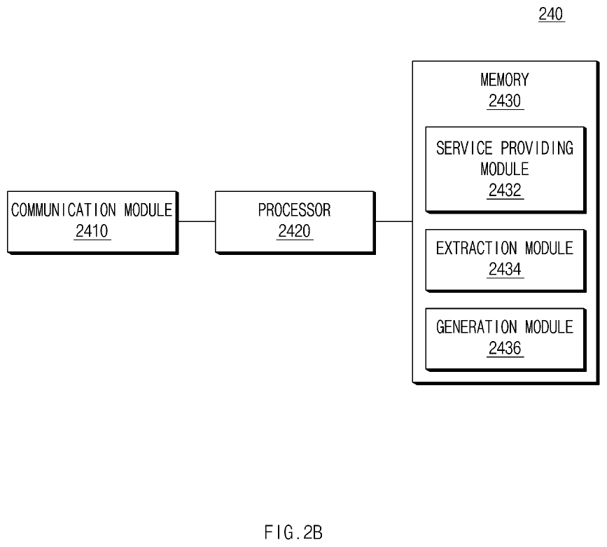

FIG. 2A is a diagram schematically showing a configuration of a group call system 200 according to various embodiments.

Referring to FIG. 2A, the group call system 200 according to various embodiments may be composed of a plurality of electronic devices (e.g., a first electronic device 210, a second electronic device 220, and a third electronic device 230) and an external device 240. Each of the electronic device (e.g., the first electronic device 210, the second electronic device 220, and the third electronic device 230) may communicate with the external device 240 via a network (e.g., the second network 199). According to one embodiment, each electronic device may be the electronic device 101 shown in FIG. 1. In addition, the external device 240 may be the electronic device 101 shown in FIG. 1.

According to various embodiments, each of the electronic devices (e.g., the first electronic device 210, the second electronic device 220, and the third electronic device 230) may obtain a speaker's uttered voice and transmit the obtained voice to an electronic device of another speaker participating in a group call or receive an uttered voice of said another speaker. According to one embodiment, each of the electronic devices (e.g., the first electronic device 210, the second electronic device 220, and the third electronic device 230) may transmit an uttered voice of a user received via a microphone to another electronic device via the external device 240. In addition, each of the electronic devices (e.g., the first electronic device 210, the second electronic device 220, and the third electronic device 230) may receive an uttered voice obtained by said another electronic device via the external device 240.

According to various embodiments, the external device 240 may include at least one server device that provides a group call service allowing the plurality of electronic devices (e.g., the first electronic device 210, the second electronic device 220, and the third electronic device 230) to make calls simultaneously, or a portable electronic device capable of providing the group call service. According to one embodiment, the external device 240 may allocate (or form) a channel (e.g., an audio channel and/or a video channel) for each of the electronic devices (e.g., the first electronic device 210, the second electronic device 220, and the third electronic device 230) participating in the group call, and receive an uttered voice from each of the electronic devices (e.g., the first electronic device 210, the second electronic device 220, and the third electronic device 230) via the allocated channel or transmit the uttered voice to each of the electronic devices (e.g., the first electronic device 210, the second electronic device 220, and the third electronic device 230). For example, the external device 240 may allocate a first channel to the first electronic device 210, a second channel to the second electronic device 220, and a third channel to the third electronic device 230. In addition, the external device 240 may transmit the uttered voice of the first electronic device 210 received via the first channel to the second electronic device 220 and the third electronic device 230 via the second channel and the third channel, respectively. Similarly, the external device 240 may transmit the uttered voice of the second electronic device 220 received via the second channel to the first electronic device 210 and the third electronic device 230 via the first and third channels, respectively, and the external device 240 may transmit the uttered voice of the third electronic device 230 received via the third channel to the first electronic device 210 and the second electronic device 220 via the first and second channels, respectively.

According to various embodiments, the external device 240 may sense simultaneous utterances while providing the group call service. The simultaneous utterances may be a situation in which uttered voices of two or more simultaneously speaking speakers overlap each other when the at least two speakers speak simultaneously or in close temporal proximity. According to one embodiment, when the simultaneous utterances are sensed, the external device 240 may generate a synthesized voice in which the utterances overlapping each other by the simultaneous utterances are processed to be sequentially reproduced, and provide the synthesized voice to at least one electronic device (e.g., the first electronic device 210, the second electronic device 220, and the third electronic device 230) participating in the group call. The synthesized voice is a connection of the overlapping utterances respectively separated from the uttered voices, and is able to prevent overlapping and loss of an uttered voice of a specific speaker caused by the simultaneous utterances.

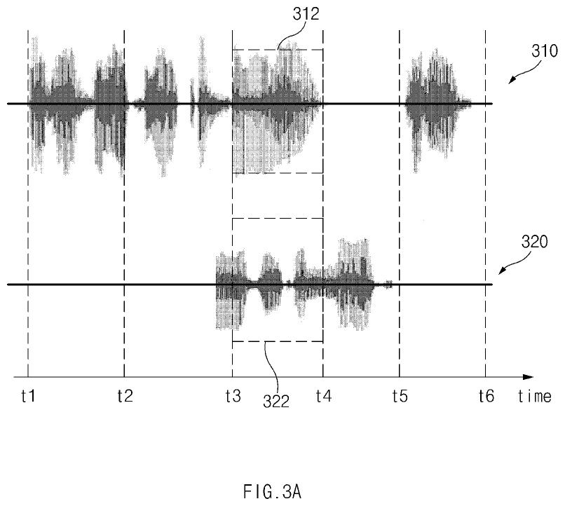

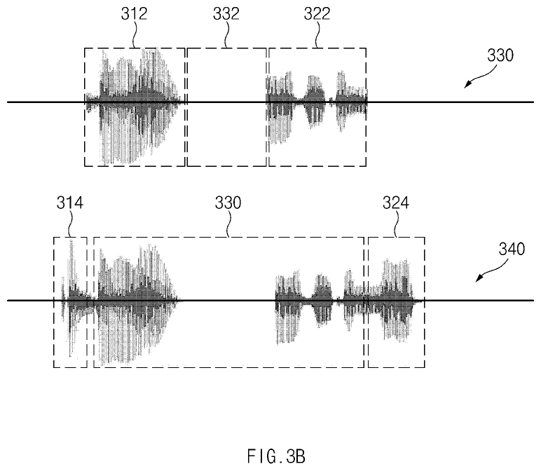

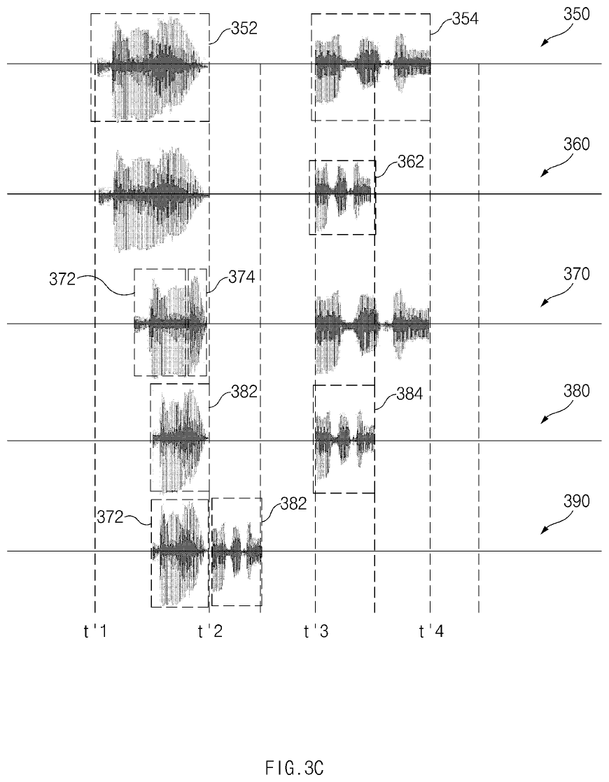

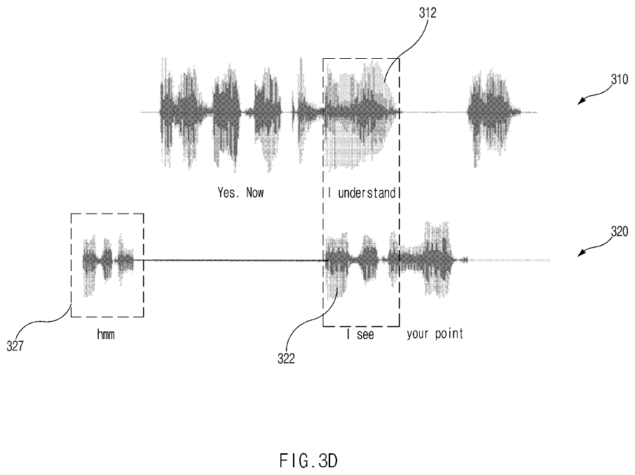

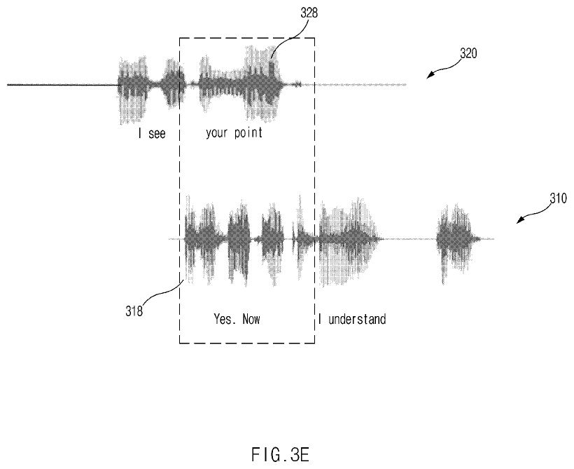

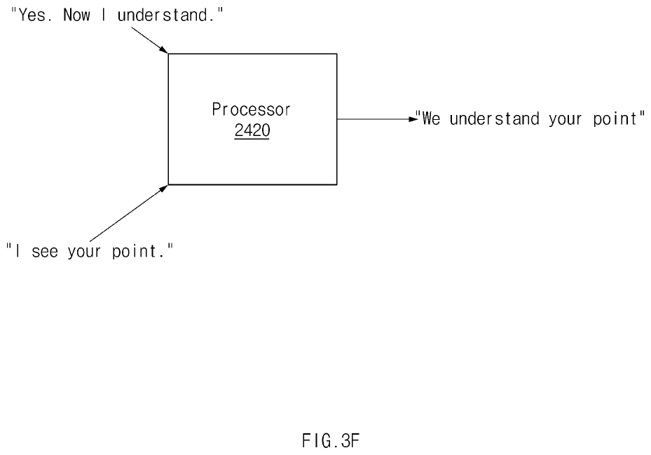

FIG. 2B is a diagram schematically showing a configuration of the external device 240 according to various embodiments. In addition, FIG. 3A is a diagram for illustrating an operation of obtaining (or extracting) the overlapping utterances in the external device 240 according to the various embodiments, FIGS. 3B, 3D, and 3E are diagrams illustrating an operation of generating the synthesized voice in the external device 240 according to the various embodiments, and FIG. 3C is a diagram for illustrating an operation of reproducing the synthesized voice in the external device 240 according to the various embodiments.

Referring to FIG. 2B, the external device 240 according to the various embodiments may correspond to at least one of the electronic device 101, which is described above via FIG. 1, an external electronic device (e.g., the electronic device 102 and the electronic device 104), and the server 108.

According to various embodiments, the external device 240 may include a communication module 2410 (e.g., the communication module 190), a processor 2420 (e.g., the processor 120), and a memory 2430 (e.g., the memory 130). However, this is merely exemplary, and the above-described components are not limited to be essential components of the external device 240. For example, the external device 240 may be implemented with more or fewer components than those shown in FIG. 2B. For example, the external device 240 may be composed of at least one input module (e.g., the input module 150), at least one display module (e.g., the display module 160), and at least one sensor module (e.g., the sensor module 176) or a power management module (e.g., the power management module 188).

The communication module 2410 may support communication with the at least one electronic device (e.g., the first electronic device 210, the second electronic device 220, and the third electronic device 230). According to various embodiments, the communication module 2410 may be a device including hardware and software for transmitting and receiving signals (e.g., commands or data) between the at least one electronic device (e.g., the first electronic device 210, the second electronic device 220, and the third electronic device 230) and the external device 240.

The processor 2420 may be operatively connected to the communication module 2410 and the memory 2430, and may control various components (e.g., hardware or software components) of the external device 240.

According to various embodiments, the processor 2420 may provide the group call service such that the plurality of electronic devices (e.g., the first electronic device 210, the second electronic device 220, and the third electronic device 230) may make calls simultaneously. According to one embodiment, while the group call is in progress, the processor 2420 may transmit an uttered voice received from the at least one electronic device (e.g., the first electronic device 210, the second electronic device 220, and the third electronic device 230) to at least one other electronic device participating in the group call.

According to various embodiments, the processor 2420 may sense the simultaneous utterances situation in which the uttered voices of the two or more simultaneously speaking speakers overlap each other when the at least two speakers speak substantially simultaneously while the group call is in progress. According to one embodiment, the processor 2420 may sense the simultaneous utterances based on time information at which the uttered voice is received via each channel. For example, the processor 2420 may sense that the simultaneous utterances have occurred when the spoken voices are received via at least two channels simultaneously or in close temporal proximity.

According to various embodiments, the processor 2420 may generate the synthesized voice based on the uttered voices of the simultaneously speaking speakers when the simultaneous utterances occur, and transmit the generated synthesized voice to the group call participant (e.g., the first electronic device 210, the second electronic device 220, and the third electronic device 230). The synthesized voice may be data processed such that the respective uttered voices uttered by the simultaneously speaking speakers are sequentially reproduced.

According to one embodiment, when a first uttered voice and a second uttered voice are received substantially simultaneously, the processor 2420 may obtain a first overlapping utterance from the first uttered voice and obtain a second overlapping utterance from the second uttered voice. For example, as shown in FIG. 3A, assuming a situation in which a first uttered voice 310 (e.g., “Yes. Now I understand”), which is uttered from a time point t1 to a time point t4, is received from the first electronic device 210 and a second uttered voice 320 (e.g., “I see your point”), which is uttered from a time point t3 to a time point t5, is received from the second electronic device 220, the processor 2420 may determine a period from the time point t3 to the time point t4 as a simultaneous utterances period. Accordingly, the processor 2420 may obtain a portion of the first uttered voice 310 from the time point t3 to the time point t4 as a first overlapping utterance 312 (e.g., “I understand”), and a portion of the second uttered voice 320 from the time point t3 to the time point t4 as a second overlapping utterance 322 (e.g., “I see”).

According to one embodiment, as shown in FIG. 3B, the processor 2420 may generate a synthesized voice 330 (e.g., “I understand I see”) obtained by continuously connecting the first overlapping utterance 312 obtained from the first uttered voice 310 with the second overlapping utterance 322 obtained from the second uttered voice 320. In this regard, the processor 2420 may optionally or additionally add a silence period (e.g., a short pause period or a silence period) 332 of a specified length between the first overlapping utterance 312 and the second overlapping utterance 322.

As another example, the processor 2420 may obtain an additional utterance based on at least one overlapping utterance and use the additional utterance to generate the synthesized voice. For example, as shown in FIG. 3B, the processor 2420 may generate a synthesized voice 340 (e.g., “Now I understand I see your point”) by obtaining a portion 314 (e.g., “Now”) corresponding to a portion of the first uttered voice (e.g., “Yes. Now I understand”) a certain time before (and/or after) the first overlapping utterance 312 (e.g., “I understand”) as a first additional utterance and connecting the portion 314 to the first overlapping utterance 312, and obtaining a portion 324 (e.g., “your point”) corresponding to a portion of the second uttered voice (e.g., “I see your point”) a certain time before (and/or after) the second overlapping utterance 322 (e.g., “I see”) as a second additional utterance and connecting the second additional utterance to the second overlapping utterance 322. Accordingly, the synthesized voice 340 including the additional utterances 314 and 324 may provide an effect of transferring a context of the overlapping utterances compared to the synthesized voice 330 composed of only the overlapping utterances 312 and 322.

According to various embodiments, the processor 2420 may determine a reproduction order of the overlapping utterances based on an utterance order of the simultaneously speaking speakers. For example, when an utterance time point (e.g., t1) of the first uttered voice 310 is earlier than an utterance time point (e.g., t3) of the second uttered voice 320, the processor 2420 may generate a synthesized voice (e.g., “I understand I see”) such that the first overlapping utterance (e.g., “I understand”) 312 is reproduced before the second overlapping utterance (e.g., “I see”) 322. Conversely, when the utterance time point of the second uttered voice 320 is earlier than the utterance time point of the first uttered voice 310, for example, as shown in FIG. 3D, when the utterance time point of the second uttered voice 320 is substantially earlier than the utterance time point of the first uttered voice 310 because of an exclamation (e.g., “hmm”) 327 or the like, the processor 2420 may generate a synthesized voice (e.g., “I see I understand”) such that the second overlapping utterance (e.g., “I see”) 322 is reproduced before the first overlapping utterance (e.g., “I understand”) 312. However, this is only exemplary, and the disclosure is not limited thereto. For example, the reproduction order of the overlapping utterances may be determined in consideration of utterance speeds, utterance volumes, and the like of the simultaneously speaking speakers.

Additionally, as shown in FIG. 3E, when the utterance time point of the second uttered voice 320 itself is earlier than the utterance time point of the first uttered voice 310 itself, the processor 2420 may obtain an overlapping portion (e.g., “your point”) 328 of the second uttered voice (e.g., “I see your point”) 320 overlapping the first uttered voice (e.g., “Yes. Now I understand”) 310 as the second overlapping utterance, and obtain an overlapping portion (e.g., “Yes. Now”) 318 of the first uttered voice 310 overlapping the second uttered voice 320 as the first overlapping utterance to generate a synthesized voice (e.g., “your point Yes, Now”).

According to various embodiments, the synthesized voice may be reproduced via the at least one electronic device (e.g., the first electronic device 210, the second electronic device 220, and the third electronic device 230) participating in the group call after the simultaneous utterances are stopped. For example, as shown with 350 in FIG. 3C, a first overlapping utterance (e.g., “I understand”) 352 in a period from t′1 to t′2 and a second overlapping utterance (e.g., “I see”) 354 in a period from t′3 to t′4 of a synthesized voice 350 may be reproduced at a first speed (or speech rate). The first speed may be a speed (a normal speed or a standard speed) (e.g., a 1× speed) substantially equal to an utterance speed of a speaker. In the reproduction of the synthesized voice 350, a subsequent utterance of the speaker may be delayed. Accordingly, as shown in 360 to 390 in FIG. 3C, the processor 2420 may process at least one overlapping voice included in the synthesized voice 350 to be reproduced at a second speed (e.g., a speed higher than 1.2 times and lower than 2 times, for example, a 1.5× speed) higher than the utterance speed (e.g., the first speed) of the speaker to reduce the delay of the subsequent utterance, so that the group call is performed smoothly.

For example, as shown with 360 in FIG. 3C, the processor 2420 may process the first overlapping utterance 352 (e.g., “I understand”) of the synthesized voice 350 (e.g., “I understand I see”) to be reproduced at the first speed, and the second overlapping utterance 354 (e.g., “I see”) to be reproduced 362 at the second speed. As described above, between the first overlapping utterance (e.g., “I understand”) and the second overlapping utterance (e.g., “I see”), in other words, from t′2 to t′3 of the synthesized voice 350, the silence period may be provided.

As another example, as shown with 370 in FIG. 3C, the processor 2420 may process a portion 372 (e.g., “I or understand”) of the first overlapping utterance 352 (e.g., “I understand”) to be reproduced at the first speed and only the other portion 374 (e.g., “understand or I”) of the first overlapping utterance 352 to be reproduced at the second speed. In this regard, the processor 2420 may process at least a portion of the second overlapping utterance 354 (e.g., “I see”) to be reproduced at the first speed or at the second speed.

As another example, as shown with 380 in FIG. 3C, the processor 2420 may process the second overlapping utterance 354 (e.g., “I see”) in addition to the first overlapping utterance 352 (e.g., “I understand”) to be reproduced 382 and 384 at the second speed.

As another example, as shown with 390 in FIG. 3C, the processor 2420 may process the second overlapping utterance 354 (e.g., “I see”) in addition to the first overlapping utterance 352 (e.g., “I understand”) to be reproduced 392 and 394 at the second speed, but may remove the silence period between the first overlapping utterance 392 and the second overlapping utterance 394. However, this is only exemplary, and the disclosure is not limited thereto. For example, the processor 2420 may remove the silence period (e.g., the silence period between words) present in the first overlapping utterance 352 (e.g., “I understand”) or the second overlapping utterance 354 (e.g., “I see”), thereby adjusting the utterance speed of the overlapping voices.

In the above embodiments, the embodiments of generating the synthesized voice by separating the overlapping utterances from the respective utterances of the simultaneously speaking speakers has been described. However, this is only exemplary, and the disclosure is not limited thereto. For example, the processor 2420 may generate a synthesized voice by continuously connecting an overlapping utterance obtained from an uttered voice of one speaker with an uttered voice of another speaker.

For example, when the first uttered voice 310 (e.g., “Yes. Now I understand”) is received from the first electronic device 210 and the second uttered voice 320 (e.g., “I see your point”) is received from the second electronic device 220, the processor 2420 may generate a synthesized voice (e.g., “I see your point I understand or I understand I see your point”) by connecting the first overlapping utterance 312 (e.g., “I understand”) of the first uttered voice 310 to the second uttered voice 320. In this regard, the processor 2420 may process at least a portion of the synthesized voice (e.g., at least a portion of the second uttered voice 320 or at least a portion of the first overlapping utterance 312) to be reproduced at the second speed higher than the first speed. Conversely, the processor 2420 may generate a synthesized voice (e.g., “I see Yes.” “Now I understand” or “Yes. Now I understand I see”) by connecting the second overlapping utterance 322 (e.g., “I see”) of the second uttered voice 320 to the first uttered voice 310.

As another example, when the first uttered voice 310 (e.g., “Yes. Now I understand”) is received from the first electronic device 210 and the second uttered voice 320 (e.g., “I see your point”) is received from the second electronic device 220, the processor 2420 may generate a synthesized voice (e.g., “Yes. Now I understand I see your point”) composed of a non-overlapping first period (e.g., “Yes. Now”) of the first uttered voice 310, a second period (e.g., “I understand I see”) overlapping the first uttered voice and the second uttered voice, and a non-overlapping third period (e.g., “your point”) of the second uttered voice 320. In this regard, a reproduction speed of at least a partial period of the synthesized voice may be adjusted. For example, a first period (e.g., “Yes. Now”) and a third period (e.g., “your point”) may be reproduced at the first speed substantially the same as the original speed of the uttered voice, and the overlapping utterance in a second period (e.g., “I understand I see”) may be reproduced at the second speed higher than the first speed. As another example, the processor 2420 may increase the reproduction speed of the first period (e.g., “Yes. Now”) and the third period (e.g., “your point”) to secure a reproduction interval (e.g., a silence interval) between the first period (e.g., “Yes. Now”) and the second period (e.g., “I understand I see”) or a reproduction interval between the second period (e.g., “I understand I see”) and the third period (e.g., “your point”), or secure a reproduction interval between the first overlapping utterance (e.g., “I understand”) and the second overlapping utterance (e.g., “I see”) of the second period (e.g., “I understand I see”).

The memory 2430 may store commands or data related to at least one other component of the external device 240. According to one embodiment, the memory 2430 may store at least a portion of the uttered voice generated during the group call.

According to various embodiments, the memory 2430 may include at least one program module. The program module may include the program 140 in FIG. 1. The at least one program module may include a service providing module 2432, an extraction module 2434, and a generation module 2436. However, this is only exemplary, and the disclosure is not limited thereto. For example, at least one of the aforementioned modules may be excluded from the configuration of the memory 2430, and conversely, other modules other than the aforementioned modules may be added to the configuration of the memory 2430. In addition, some of the aforementioned modules may be integrated into other modules.

According to one embodiment, the service providing module 2432 may include a command for providing the group call service allowing the plurality of electronic devices (e.g., the first electronic device 210, the second electronic device 220, and the third electronic device 230) to make calls simultaneously, and sensing the simultaneous utterances in which the at least two speakers substantially simultaneously utter while the group call is in progress. According to one embodiment, the extraction module 2434 may include a command for obtaining the overlapping utterances from the uttered voice. According to one embodiment, the generation module 2436 may include a command for generating the synthesized voice based on the overlapping utterances. In this regard, the generation module 2436 may include a command for adjusting the reproduction speed of the synthesized voice.

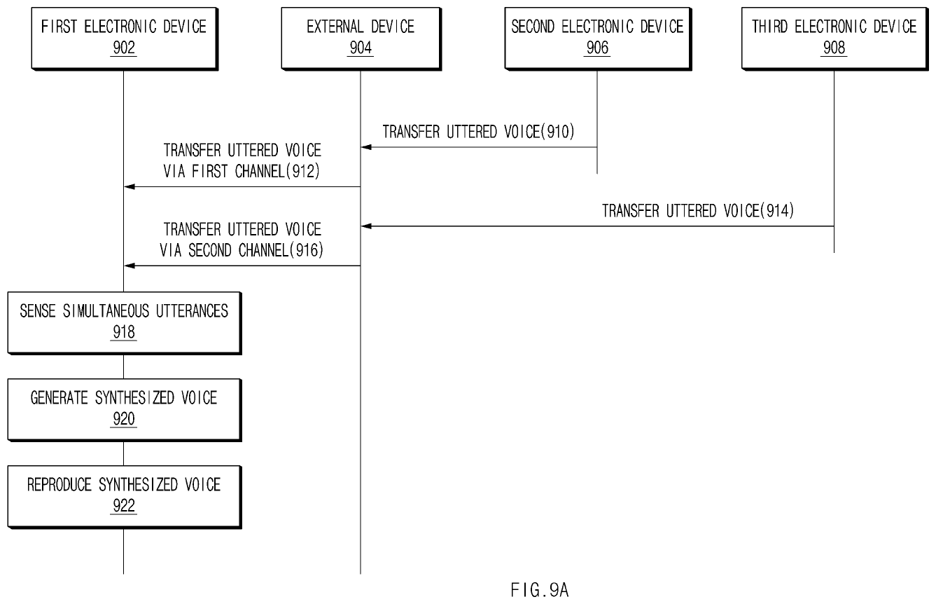

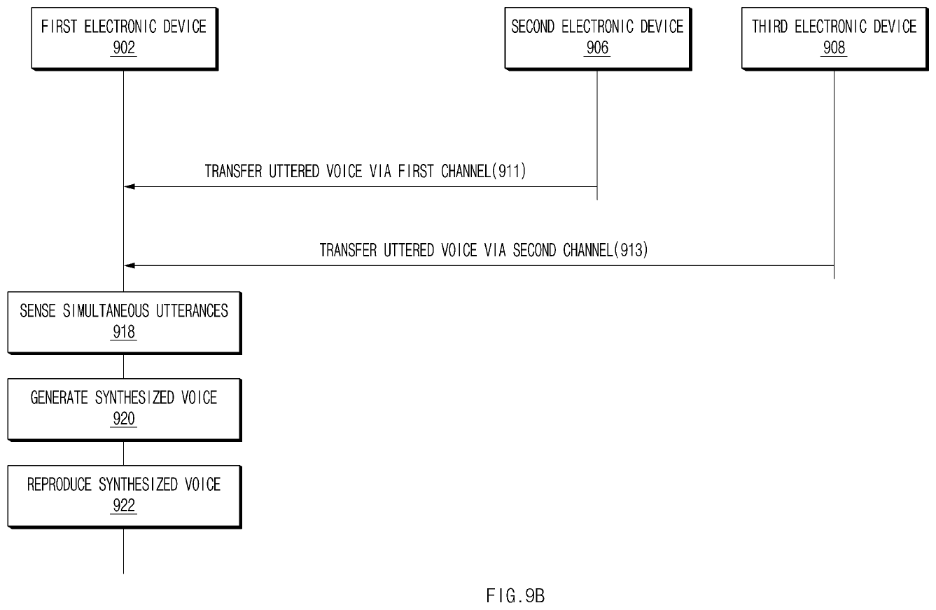

In the above embodiments, the configuration in which the synthesized voice is generated by the external device 240 has been described, but the disclosure is not limited thereto. For example, the synthesized voice may be generated by the at least one electronic device (e.g., the first electronic device 210, the second electronic device 220, and the third electronic device 230) as will be described later with reference to FIGS. 9A and 9B.

With reference to FIG. 3F, an addition to the above embodiments, the memory 2430 may also include at least one natural language processing (NLP) algorithm whereby the statements made by the first uttered voice 310 (e.g., “Yes. Now I understand”) and the statements made by the second uttered voice 320 (e.g., “I see your point”) are received and interpreted by the processor 2420. With this tool available, the generation of the synthesized voice based on the overlapping utterances can be modified to avoid repetitive or redundant statements, verbal tics and/or other ambient noise and can also be modified to add or change the statements themselves. For example, where the first uttered voice 310 (e.g., “Yes. Now I understand”) and the second uttered voice 320 (e.g., “I see your point”) are generally in agreement in terms of sentiment, the synthesized voice can capture the sentiment using different, inclusive language (e.g., “We understand your point”).

An electronic device (e.g., the external device 240) according to various embodiments may include a communication module (e.g., the communication module 2410), and a processor (e.g., the processor 2420) operatively connected to the communication module, and the processor may receive and store a first uttered voice related to at least a first external device and a second uttered voice related to a second external device, transmit the first uttered voice or the second uttered voice having a first reproduction speed to at least the first external device and the second external device when a single utterance is sensed based on the first uttered voice and the second uttered voice, and convert a reproduction speed of at least a portion of a synthesized voice where at least a first overlapping utterance of the first uttered voice and at least a second overlapping utterance of the second uttered voice are continuously connected to each other to a second reproduction speed different from the first reproduction speed and transfer the synthesized voice to at least the first external device and the second external device when simultaneous utterances are sensed based on the first uttered voice and the second uttered voice.

According to various embodiments, the first reproduction speed may be a speed substantially equal to an utterance speed of a speaker, and the second reproduction speed may include a speed higher than the first reproduction speed.

According to various embodiments, the processor may identify a first utterance time period related to the first overlapping utterance and a second utterance time period related to the second overlapping utterance, and determine the second reproduction speed such that the synthesized voice is reproduced within a time period smaller than a sum of the first utterance time period and the second utterance time period.

According to various embodiments, the processor may convert a reproduction speed of at least one of the first overlapping utterance and the second overlapping utterance into the second reproduction speed.

According to various embodiments, the processor may convert a reproduction speed of at least one of a portion of the first overlapping utterance and a portion of the second overlapping utterance into the second reproduction speed.

According to various embodiments, the processor may generate the synthesized voice with a silence period added between the first overlapping utterance and the second overlapping utterance.

According to various embodiments, the processor may obtain a portion of the first uttered voice corresponding to a certain range based on the first overlapping utterance as a first additional utterance, obtain a portion of the second uttered voice corresponding to a certain range based on the second overlapping utterance as a second additional utterance, and use the first additional utterance and the second additional utterance to generate the synthesized voice.

According to various embodiments, the processor may receive information related to the second reproduction speed from the first external device or the second external device, and convert the synthesized voice based on the received information.

According to various embodiments, the processor may convert the synthesized voice such that a certain level of pitch is maintained for the first overlapping utterance and the second overlapping utterance.

An electronic device (e.g., the first electronic device 210, the second electronic device 220, and the third electronic device 230) according to various embodiments may include a communication module (e.g., the communication module 2410), a microphone (e.g., the input module 150), an output module (e.g., the sound output module 155), and a processor operatively connected to the communication module, the microphone, and the output module, and the processor may transmit an uttered voice obtained via the microphone to at least a first counterpart communication device and a second counterpart communication device, receive a first uttered voice obtained by the first counterpart communication device and a second uttered voice obtained by the second counterpart communication device, sense a single utterance or simultaneous utterances based on the received first uttered voice and second uttered voice, output the first uttered voice or the second uttered voice having a first reproduction speed when the single utterance is sensed, and generate a synthesized voice where at least a first overlapping utterance of the first uttered voice and at least a second overlapping utterance of the second uttered voice are continuously connected to each other and output the synthesized voice at a second reproduction speed different from the first reproduction speed when the simultaneous utterances are sensed.

According to various embodiments, the first speed may be substantially the same as an utterance speed of a speaker, and the second speed may include a speed higher than the first speed.

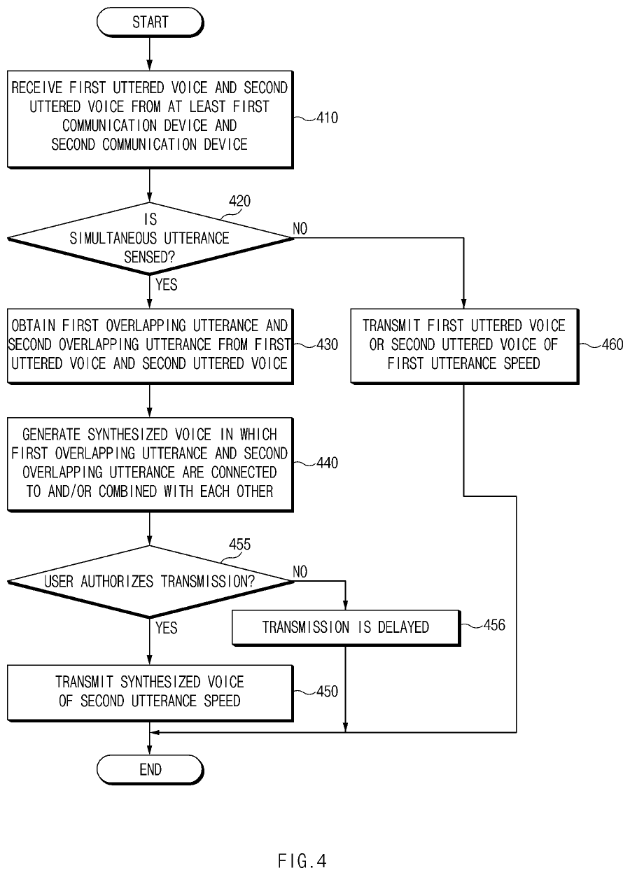

FIG. 4 is a flowchart illustrating an operation of providing a group call service in an electronic device according to various embodiments. In a following description, the electronic device may be the external device described above with reference to FIG. 2A, and a first communication device and a second communication device may be the at least one electronic device described above with reference to FIG. 2A.

Referring to FIG. 4, in operation 410, the electronic device 240 (or the processor 2420) according to various embodiments may receive uttered voices from at least the first communication device and the second communication device participating in the group call. According to one embodiment, the electronic device 240 may receive a first uttered voice via a first channel allocated to the first communication device and receive a second uttered voice via a second channel allocated to the second communication device. However, this is only exemplary, and the disclosure is not limited thereto. For example, when ‘n’ communication devices are participating in the group call, the electronic device 240 may receive ‘n’ uttered voices.

According to various embodiments, in operation 420, the electronic device 240 may determine whether the simultaneous utterances are sensed based on the first uttered voice and the second uttered voice. The simultaneous utterances may be a situation in which a speaker of at least the first communication device and a speaker of the second communication device utter substantially simultaneously. According to one embodiment, the electronic device 240 may sense the simultaneous utterances based on a time at which the uttered voices are received via the first channel and the second channel.

According to various embodiments, when the simultaneous utterances are not sensed, that is, when a single utterance occurs, in operation 460, the electronic device 240 may transmit the uttered voice of a first utterance speed to a communication device. The first utterance speed may be substantially the same as an utterance speed of a speaker. For example, the electronic device 240 may transmit the first uttered voice corresponding to an utterance speed of a first speaker using the first communication device to the second communication device. In addition, the electronic device 240 may transmit the second uttered voice corresponding to an utterance speed of a second speaker using the second communication device to the first communication device.

According to various embodiments, when the simultaneous utterances are sensed, in operation 430, the electronic device 240 may obtain overlapping utterances from the received uttered voices. According to one embodiment, the electronic device 240 may obtain a first overlapping utterance overlapping the second uttered voice from the first uttered voice. In addition, the electronic device 240 may obtain a second overlapping utterance overlapping the first uttered voice from the second uttered voice. For example, the first overlapping utterance may include at least a portion belonging to the first uttered voice of a portion where the first uttered voice and the second uttered voice overlap each other. In addition, the second overlapping utterance may include at least a portion belonging to the second uttered voice of a portion where the first uttered voice and the second uttered voice overlap each other.

According to various embodiments, in operation 440, the electronic device 240 may generate a synthesized voice in which the first overlapping utterance and the second overlapping utterance are connected to each other. According to one embodiment, the electronic device 240 may generate the synthesized voice by connecting the overlapping utterances extracted from the respective uttered voices. For example, the electronic device 240 may generate a synthesized voice by connecting the second overlapping utterance after the first overlapping utterance. As another example, the electronic device 240 may generate a synthesized voice by connecting the first overlapping utterance after the second overlapping utterance. As another example, the electronic device 240 may generate a synthesized voice in which a silence period of a certain length is formed between the first overlapping utterance and the second overlapping utterance. According to another embodiment, the electronic device 240 may generate a synthesized voice by connecting an overlapping utterance extracted from an uttered voice with an uttered voice. For example, the electronic device 240 may generate a synthesized voice by connecting the second overlapping utterance after the first uttered voice. As another example, the electronic device 240 may generate a synthesized voice by connecting the second uttered voice after the first overlapping utterance.

According to additional various embodiments, in operation 440, the electronic device 240 may generate a synthesized voice in which the first overlapping utterance and the second overlapping utterance are connected to and/or combined with each other. In the case of the combination of the first and second overlapping utterances being combined, the electronic device 240 may be capable of NLP whereby the first and second utterances are received and interpreted such that the synthesized voice can be modified to avoid repetitive or redundant statements, verbal tics and/or other ambient noise and can also be modified to add or change the statements themselves. For example, where the first and second utterances are generally in agreement in terms of sentiment, the synthesized voice can capture the sentiment using different, inclusive language.

According to various embodiments, in operation 450, the electronic device 240 may transmit a synthesized voice of a second utterance speed. The second utterance speed may be higher than the utterance speed of the speaker. According to one embodiment, the electronic device 240 may process at least one of the first overlapping utterance and the second overlapping utterance included in the synthesized voice to be reproduced at the second utterance speed higher than the first utterance speed. In addition, the electronic device 240 may adjust the utterance speed for at least a portion of the first overlapping utterance and at least a portion of the second overlapping utterance.

According to various additional embodiments, in operation 455, the electronic device 240 may inform the user as to an available transmission of a synthesized voice and request authorization to proceed with transmission. If the user authorizes the transmission, control proceed to operation 450. If the user refuses the transmission, the transmission is delayed 456. Optionally, the user may also be prompted as to how long the delay should last.

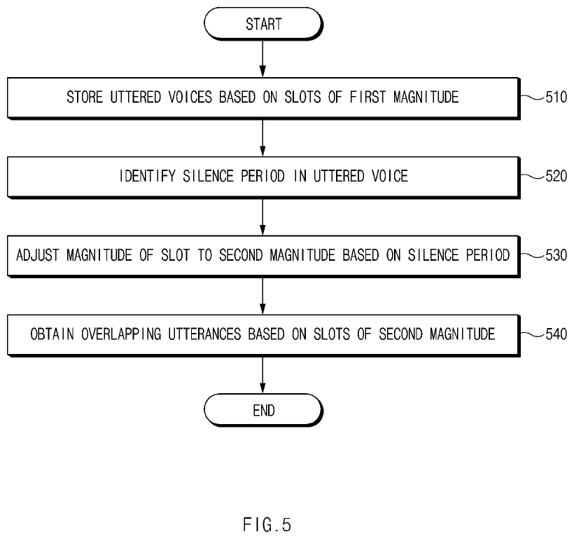

FIG. 5 is a flowchart illustrating an operation of obtaining overlapping utterances in an electronic device according to various embodiments. Operations in FIG. 5 to be described below may represent various embodiments of at least one of operations 410 to 430 in FIG. 4.

Referring to FIG. 5, in operation 510, the electronic device 240 (or the processor 2420) according to various embodiments may store the uttered voices received from at least the first communication device and the second communication device based on slots (or windows) of a first magnitude. The slot may be a range in which the overlapping utterances may be extracted from the uttered voice. According to one embodiment, the electronic device 240 may store the first uttered voice received from the first communication device in a first slot of the first magnitude, and may store the second uttered voice received from the second communication device in a second slot of the first magnitude. For example, the slot of the first magnitude may be a minimum range in which the overlapping utterances may be extracted, and the range in which the overlapping utterances may be extracted from the uttered voices may increase as the slot magnitude increases.

According to various embodiments, in operation 520, the electronic device 240 may identify a silence period in an uttered voice while the simultaneous utterances are sensed. The silence period may be a period in which the utterance of the speaker is stopped for a specified time period (e.g., 3 seconds). For example, the electronic device 240 may identify a silence period for each channel by identifying a time point at which the uttered voice is not received for a specified time period after receiving the uttered voice via each channel.

According to various embodiments, in operation 530, the electronic device 240 may adjust the magnitude of the slot to a second magnitude greater than the first magnitude based on the silence period. The second magnitude may correspond to a period from a time point at which the utterance starts to a time point at which the silence period occurs. According to one embodiment, while the simultaneous utterances are sensed, the electronic device 240 may expand the magnitude of the first slot to the second magnitude based on the silence period of the first uttered voice, and expand the magnitude of the second slot based on the silence period of the second uttered voice.

According to various embodiments, in operation 540, the electronic device 240 may obtain the overlapping utterances based on the slots of the second magnitude. According to one embodiment, the electronic device 240 may obtain an uttered voice corresponding to the slot of the second magnitude at the time point at which the simultaneous utterances are stopped as the overlapping utterance. For example, the electronic device 240 may obtain the first overlapping utterance corresponding to the first slot of the second magnitude from the first uttered voice and obtain the second overlapping utterance corresponding to the second slot of the second magnitude from the second uttered voice.

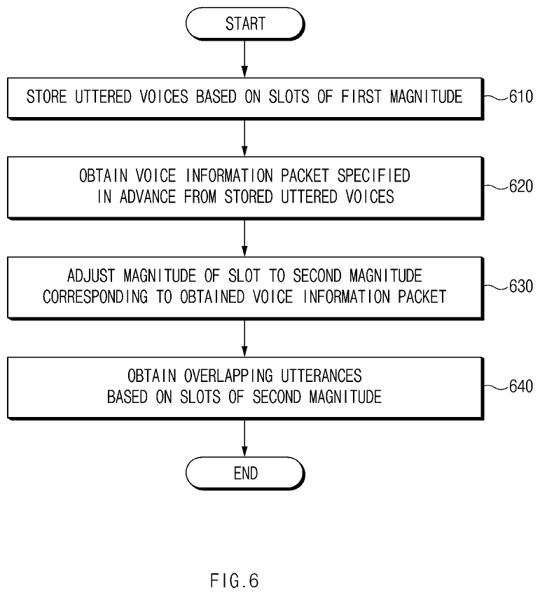

FIG. 6 is a flowchart illustrating another operation of obtaining overlapping utterances in an electronic device according to various embodiments. Operations in FIG. 6 to be described below may represent various embodiments of at least one of operations 410 to 430 in FIG. 4. Referring to FIG. 6, in operation 610, the electronic device 240 (or the processor 2420) according to various embodiments may store the uttered voices received from at least the first communication device and the second communication device based on the slots (or the windows) of the first magnitude. According to one embodiment, as described above with reference to FIG. 5, the electronic device 240 may store the first uttered voice received from the first communication device based on the first slot of the first magnitude, and store the second uttered voice received from the second communication device based on the second slot of the first magnitude.

According to various embodiments, while the simultaneous utterances are sensed, in operation 620, the electronic device 240 may compare the stored uttered voice with a voice information database to obtain voice information (i.e., a voice information packet) having a certain level of similarity. The voice information database may include at least one voice information packet defined by at least one word (e.g., a short-answer word) or a combination of at least two words where the simultaneous utterances may occur based on characteristics of a group call (e.g., meeting, class, and the like). According to one embodiment, the electronic device 240 may obtain at least one voice information packet included in the voice information database and at least one voice information packet having the certain level of similarity from the first uttered voice and the second uttered voice.

According to various embodiments, in operation 630, the electronic device 240 may adjust the magnitude of the slot to the second magnitude corresponding to the obtained voice information packet. According to one embodiment, the electronic device 240 may expand the magnitude of the first slot to the corresponding second magnitude based on the voice information packet obtained from the first uttered voice, and expand the magnitude of the second slot to the corresponding second magnitude based on the voice information packet obtained from the second uttered voice.

According to various embodiments, in operation 640, the electronic device 240 may obtain the overlapping utterances based on the slots of the second magnitude. According to one embodiment, the electronic device 240 may obtain the first overlapping utterance corresponding to the first slot of the second magnitude from the first uttered voice, and obtain the second overlapping utterance corresponding to the second slot of the second magnitude from the second uttered voice.

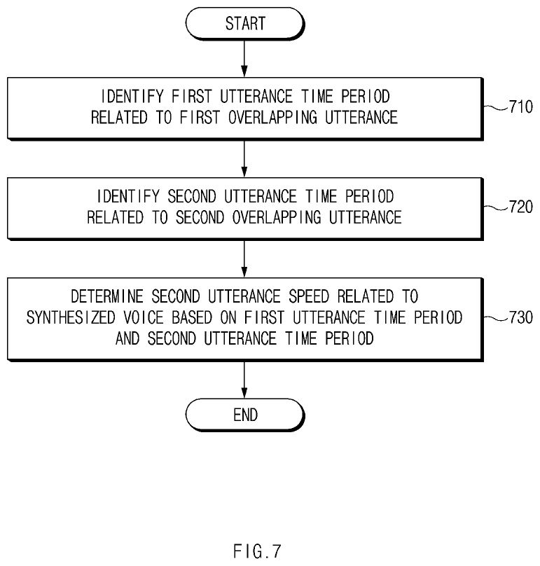

FIG. 7 is a flowchart illustrating an operation of determining an utterance speed of a synthesized voice in an electronic device according to various embodiments. Operations in FIG. 7 to be described below may represent various embodiments of at least one of operations 440 to 450 in FIG. 4.

Referring to FIG. 7, in operation 710, the electronic device 240 (or the processor 2420) according to various embodiments may identify the first utterance time period related to the first overlapping utterance. According to one embodiment, the electronic device 240 may identify a time period defined by the start time point and the end time point of the first overlapping utterance.

According to various embodiments, in operation 720, the electronic device 240 may identify the second utterance time period related to the second overlapping utterance. According to one embodiment, the electronic device 240 may identify a time period defined by the start time point and the end time point of the second overlapping utterance.

According to various embodiments, in operation 730, the electronic device 240 may determine the second utterance speed related to the synthesized voice based on the first utterance time period and the second utterance time period. According to one embodiment, the electronic device 240 may process the synthesized voice to be reproduced within a time period (e.g., 2 seconds) smaller than a sum (e.g., 3 seconds) of the first utterance time period (e.g., 2 seconds) and the second utterance time period (e.g., 1 second). For example, the electronic device 240 may process at least a portion of the first overlapping utterance and the second overlapping utterance to be reproduced at a speed greater than the first speed (the normal speed or the standard speed).

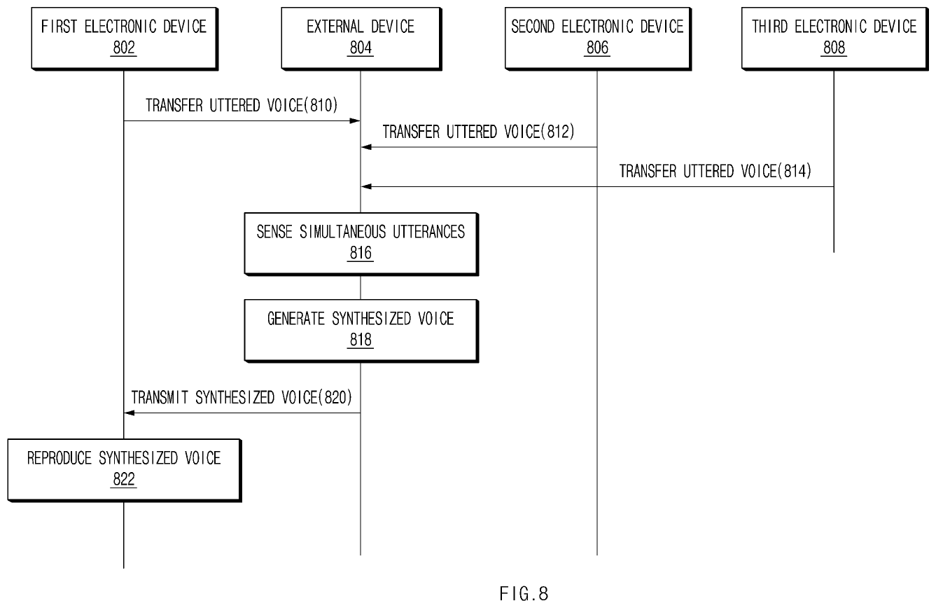

FIG. 8 is a diagram illustrating an operation of a group call system according to various embodiments.

Referring to FIG. 8, a group call system according to various embodiments may be composed of a plurality of electronic devices (e.g., a first electronic device 802, a second electronic device 806, and a third electronic device 808) and an external device 804.

According to various embodiments, as in operations 810 to 814, each of the electronic devices (e.g., the first electronic device 802, the second electronic device 806, and the third electronic device 808) may transfer an uttered voice of a user received via a microphone to the external device 804. According to one embodiment, the first electronic device 802 may transmit a first uttered voice via a first channel, the second electronic device 806 may transmit a second uttered voice via a second channel, and the third electronic device 808 may transmit a third uttered voice via a third channel.

According to various embodiments, like operation 816, the external device 804 may sense simultaneous utterances. According to one embodiment, the external device 804 may sense that the simultaneous utterances have occurred when the uttered voices are received via at least two channels simultaneously or in close temporal proximity.

According to various embodiments, like operation 818, the external device 804 may generate a synthesized voice based on the uttered voices of the simultaneously speaking speakers in response to the sensing of the occurrence of the simultaneous utterances. According to one embodiment, the external device 804 may perform at least some of operations 430 to 450 in FIG. 4 described above to generate the synthesized voice.

According to various embodiments, as in operation 820, the external device 804 may transmit the synthesized voice to the at least one electronic device (e.g., the first electronic device 802, the second electronic device 806, and the third electronic device 808). According to one embodiment, the external device 804 may transmit the synthesized voice only to at least one electronic device (e.g., the first electronic device 802) where the simultaneous utterances have not occurred. As another example, the external device 804 may transmit the synthesized voice to all of the electronic devices participating in the group call.

According to various embodiments, as in operation 822, the at least one electronic device (e.g., the first electronic device 802, the second electronic device 806, and the third electronic device 808) may reproduce the synthesized voice received from the external device 804.

FIG. 9A is a diagram showing another operation of a group call system according to various embodiments. The group call system to be described below is different from the group call system described with reference to FIG. 8 in that an electronic device rather than an external device senses an occurrence of simultaneous utterances and generates a synthesized voice.

Referring to FIG. 9A, the group call system according to various embodiments may be composed of a plurality of electronic devices (e.g., a first electronic device 902, a second electronic device 906, and a third electronic device 908) and an external device 904.

According to various embodiments, at least one electronic device (e.g., the first electronic device 902, the second electronic device 906, and the third electronic device 908) may receive an uttered voice obtained by another electronic device. According to one embodiment, the first electronic device 902 may receive uttered voices of users received via microphones of the second electronic device 906 and the third electronic device 908. In this regard, as in operations 910 and 912, the second electronic device 906 may transmit the uttered voice of the user to the external device 904, and the external device 904 may transmit the received uttered voice to the first electronic device 902 via a first channel. In addition, like operations 914 and 916, the third electronic device 908 may transmit the uttered voice of the user to the external device 904, and the external device 904 may transmit the received uttered voice to the first electronic device 902 via a second channel. For example, the first channel may be a channel set in the first electronic device 902 to receive the uttered voice of the second electronic device 906, and the second channel may be a channel set in the first electronic device 902 to receive the uttered voice of the third electronic device 908.

According to various embodiments, like operation 918, the at least one electronic device (e.g., the first electronic device 902) may sense simultaneous utterances based on the received uttered voice. According to one embodiment, the at least one electronic device (e.g., the first electronic device 902) may sense that the simultaneous utterances have occurred when the uttered voices are received via the first channel and the second channel simultaneously or in close temporal proximity.

According to various embodiments, as in operation 920, the at least one electronic device (e.g., the first electronic device 902) may generate the synthesized voice based on the uttered voices of the simultaneously speaking speakers in response to the sensing of the occurrence of the simultaneous utterances. According to one embodiment, the at least one electronic device (e.g., the first electronic device 902) may perform at least some of operations 430 to 450 in FIG. 4 to generate the synthesized voice.

According to various embodiments, like operation 922, the at least one electronic device (e.g., the first electronic device 902) may reproduce the generated synthesized voice.

In the above embodiment, the group call system composed of the plurality of electronic devices (e.g., the first electronic device 902, the second electronic device 906, and the third electronic device 908) and the external device 904 has been described. However, this is only exemplary, and the disclosure is not limited thereto. For example, as shown in FIG. 9B, a group call system according to various embodiments may be composed of only the plurality of electronic devices (e.g., the first electronic device 902, the second electronic device 906, and the third electronic device 908).

According to one embodiment, the at least one electronic device (e.g., the first electronic device 902, the second electronic device 906, and the third electronic device 908) may receive the uttered voice obtained by another electronic device. In this regard, like operations 911 and 913, the second electronic device 906 may transmit the uttered voice of the user to the first electronic device 902 via the first channel, and the third electronic device 908 may transmit the uttered voice of the user to the first electronic device 902 via the second channel.

According to one embodiment, as in operations 918 to 922 described above with FIG. 9A, the at least one electronic device (e.g., the first electronic device 902) may sense the simultaneous utterances based on the received uttered voices, may generate the synthesized voice based on the uttered voices of the simultaneously speaking speakers, and reproduce the generated synthesized voice.

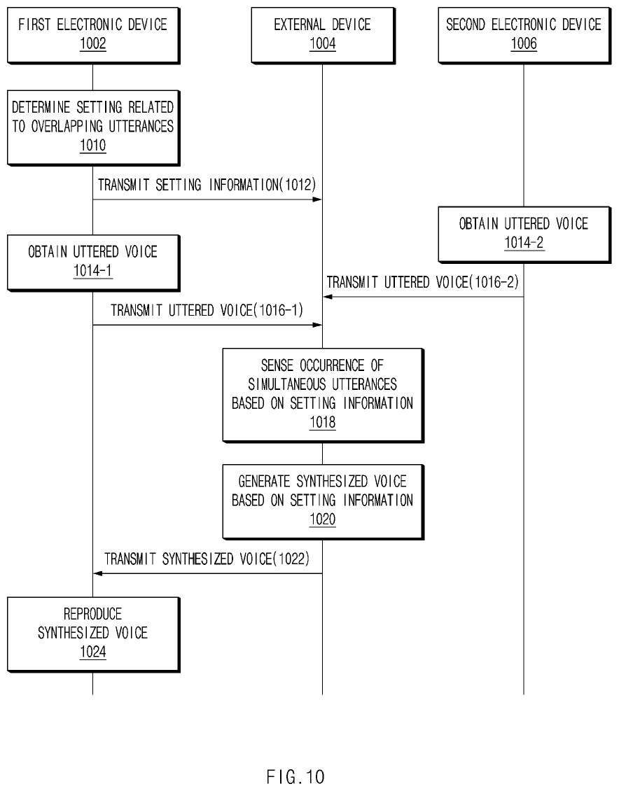

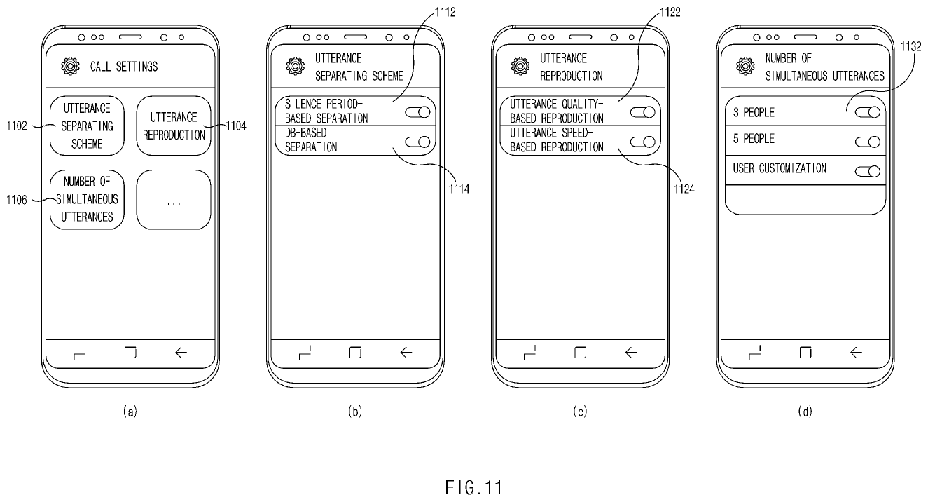

FIG. 10 is a diagram illustrating another operation of a group call system according to various embodiments. In addition, FIG. 11 is a diagram for illustrating a parameter setting operation of a synthesized voice according to various embodiments. The group call system to be described below is similar to the group call system described with reference to FIG. 8 in that an external device senses an occurrence of simultaneous utterances and generates a synthesized voice, but is different therefrom that an electronic device sets parameters for the synthesized voice.

Referring to FIG. 10, the group call system according to various embodiments may be composed of a plurality of electronic devices (e.g., a first electronic device 1002 and a second electronic device 1006) and an external device 1004.

According to various embodiments, as in operation 1010, at least one electronic device (e.g., the first electronic device 1002 and the second electronic device 1006) may set the parameters related to the synthesized voice. The parameters may include a scheme for separating (or extracting) overlapping utterances from uttered voices, a scheme for reproducing the overlapping utterances, and the number of allowed simultaneously speaking speakers. According to one embodiment, the parameters may be set by an electronic device that has established the group call service. However, this is only exemplary, and the disclosure is not limited thereto.

According to one embodiment, the at least one electronic device (e.g., the first electronic device 1002 and the second electronic device 1006) may output a user interface including at least one menu for parameter setting as shown in (a) in FIG. 11 before or while the group call service is executed. For example, the user interface may include an object 1102 for setting the scheme for separating (or extracting) the overlapping utterances from the uttered voices, an object 1104 for setting the scheme of reproducing the overlapping utterances, and an object 1106 for setting the number of allowed simultaneously speaking speakers.

According to one embodiment, as shown in (b) in FIG. 11, the at least one electronic device (e.g., the first electronic device 1002 and the second electronic device 1006) may select at least one of a scheme 1112 for obtaining the overlapping utterances from the uttered voices based on the silence period described with FIG. 5 based on a user input or a scheme 1114 for obtaining the overlapping utterances from the uttered voices based on the database described with FIG. 6.

According to one embodiment, as shown in (c) in FIG. 11, the at least one electronic device (e.g., the first electronic device 1002 and the second electronic device 1006) may select one of a scheme 1122 for reproducing the overlapping utterances based on an utterance quality based on the user input and a scheme 1124 for reproducing the overlapping utterances based on an utterance speed. The scheme based on the utterance quality may be a scheme in which a reproduction speed is adjusted within a range in which a pitch of the overlapping utterances is maintained at a certain level. In addition, the scheme based on the utterance speed may be a scheme in which the pitch of the overlapping utterances is maintained below the certain level, but the reproduction speed is adjusted to be higher than that in the scheme based on the utterance quality.

According to one embodiment, as shown in (d) in FIG. 11, the at least one electronic device (e.g., the first electronic device 1002 and the second electronic device 1006) may set 1132 the number of allowed simultaneously speaking speakers based on the user input. The set number of simultaneously speaking speakers may be the maximum number of overlapping utterances that may be included in the synthesized voice.

According to various embodiments, like operation 1012, the at least one electronic device (e.g., the first electronic device 1002 and the second electronic device 1006) may transmit parameter setting information to the external device 1004.

According to various embodiments, each of the electronic devices (e.g., the first electronic device 1002 and the second electronic device 1006) may transmit the uttered voice of the user received via a microphone to the external device 1004. According to one embodiment, like operations 1014-1 and 1016-1, the first electronic device 1002 may obtain the uttered voice and transmit the uttered voice to the external device 1004. In addition, like operations 1014-2 and 1016-2, the second electronic device 1006 may also obtain the uttered voice and transmit the uttered voice to the external device 1004.

According to various embodiments, like operations 1018 and 1020, the external device 1004 may sense the simultaneous utterances and generate the synthesized voice based on the parameter setting information. For example, the external device 1004 may generate the synthesized voice based on the scheme for obtaining the overlapping utterances, the scheme for reproducing the overlapping utterances, and the number of simultaneously speaking speakers set by the at least one electronic device (e.g., the first electronic device 1002 and the second electronic device 1006). Regarding the scheme for obtaining the overlapping utterances, when both the silence period-based separation scheme and the database-based separation scheme are selected, the external device 1004 may obtain the overlapping utterances by simultaneously using the two schemes. In this regard, when the overlapping utterances are obtained by one (e.g., silence period-based) of the silence period-based obtaining scheme and the database-based obtaining scheme, the external device 1004 may stop an operation based on the other (e.g., database-based).

According to various embodiments, as in operation 1022, the external device 1004 may transmit the synthesized voice to the at least one electronic device (e.g., the first electronic device 1002 and the second electronic device 1006). Accordingly, the at least one electronic device (e.g., the first electronic device 1002 and the second electronic device 1006) may reproduce the received synthesized voice as in operation 1024.

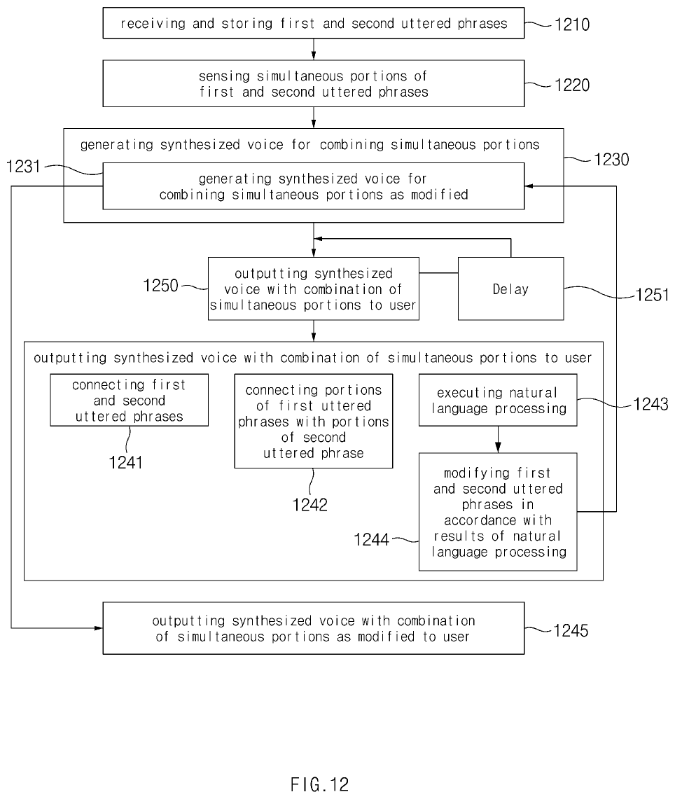

With reference to FIG. 12, an electronic device operating method is provided in accordance with various embodiments similar to those described above. The electronic device operating method includes at operation 1210 receiving and storing first and second uttered phrases from first and second external devices, respectively, sensing simultaneous portions of the first and second uttered phrases at operation 1220, generating a synthesized voice for combining the simultaneous portions at operation 1230 and outputting the synthesized voice with a combination of the simultaneous portions to a user at operation 1240.

The outputting of operation 1240 can include one or more of connecting the first and second uttered phrases at operation 1241, connecting portions of the first uttered phrases with portions of the second uttered phrase at operation 1242 and, at operation 1243, executing natural language processing with respect to the first and second uttered phrases and modifying the first and second uttered phrases in accordance with results of the natural language processing at operation 1244 (in which case the generating of operation 1230 includes generating, at operation 1231, the synthesized voice for combining the simultaneous portions as modified and the outputting of operation 1240 further includes outputting, at operation 1245, the synthesized voice with a combination of the simultaneous portions as modified to a user).

The method can also include requesting, at operation 1250, authorization to proceed with the outputting of operation 1240 from the user and, in an event the user does not provide such authorization, delaying the outputting in accordance with user instructions at operation 1251.

A method for operating an electronic device (e.g., the external device 240) according to various embodiments may include receiving and storing a first uttered voice related to at least a first external device and a second uttered voice related to a second external device, sensing a single utterance or simultaneous utterances based on the first uttered voice and the second uttered voice, transmitting the first uttered voice or the second uttered voice having a first reproduction speed to at least the first external device and the second external device when the single utterance is sensed, and converting a reproduction speed of at least a portion of a synthesized voice where at least a first overlapping utterance of the first uttered voice and at least a second overlapping utterance of the second uttered voice are continuously connected to each other to a second reproduction speed different from the first reproduction speed and transferring the synthesized voice to at least the first external device and the second external device when the simultaneous utterances are sensed.

According to various embodiments, the first reproduction speed may be a speed substantially equal to an utterance speed of a speaker, and the second reproduction speed may include a speed higher than the first reproduction speed.

According to various embodiments, the method may further include identifying a first utterance time period related to the first overlapping utterance and a second utterance time period related to the second overlapping utterance, and determining the second reproduction speed such that the synthesized voice is reproduced within a time period smaller than a sum of the first utterance time period and the second utterance time period.

According to various embodiments, the method may further include converting a reproduction speed of at least one of the first overlapping utterance and the second overlapping utterance into the second reproduction speed.

According to various embodiments, the method may further include converting a reproduction speed of at least one of a portion of the first overlapping utterance and a portion of the second overlapping utterance into the second reproduction speed.

According to various embodiments, the method may further include generating the synthesized voice with a silence period added between the first overlapping utterance and the second overlapping utterance.

According to various embodiments, the method may further include obtaining a portion of the first uttered voice corresponding to a certain range based on the first overlapping utterance as a first additional utterance, obtaining a portion of the second uttered voice corresponding to a certain range based on the second overlapping utterance as a second additional utterance, and using the first additional utterance and the second additional utterance to generate the synthesized voice.

According to various embodiments, the method may further include receiving information related to the second reproduction speed from the first external device or the second external device, and converting the synthesized voice based on the received information.

According to various embodiments, the method may further include converting the synthesized voice such that a certain level of pitch is maintained for the first overlapping utterance and the second overlapping utterance.

1. An electronic device comprising:
a communication module; and
a processor operatively connected to the communication module,
wherein the processor is configured to:
receive and store a first uttered voice related to at least a first external device and a second uttered voice related to a second external device;
transmit the first uttered voice or the second uttered voice having a first reproduction speed to at least the first external device and the second external device when a single utterance is sensed based on the first uttered voice and the second uttered voice; and
convert a reproduction speed of at least a portion of a synthesized voice where at least a first overlapping utterance of the first uttered voice and at least a second overlapping utterance of the second uttered voice are continuously connected to each other to a second reproduction speed different from the first reproduction speed and transfer the synthesized voice to at least the first external device and the second external device when simultaneous utterances are sensed based on the first uttered voice and the second uttered voice.

2. The electronic device of claim 1, wherein the first reproduction speed is a speed substantially equal to an utterance speed of a speaker, and the second reproduction speed includes a speed higher than the first reproduction speed.

3. The electronic device of claim 1, wherein the processor is configured to:
identify a first utterance time period related to the first overlapping utterance and a second utterance time period related to the second overlapping utterance; and
determine the second reproduction speed such that the synthesized voice is reproduced within a time period smaller than a sum of the first utterance time period and the second utterance time period.

4. The electronic device of claim 1, wherein the processor is configured to convert a reproduction speed of at least one of at least a portion of the first overlapping utterance and at least a portion of the second overlapping utterance into the second reproduction speed.

5. The electronic device of claim 1, wherein the processor is configured to generate the synthesized voice with a silence period added between the first overlapping utterance and the second overlapping utterance.

6. The electronic device of claim 1, wherein the processor is configured to:
obtain a portion of the first uttered voice corresponding to a certain range based on the first overlapping utterance as a first additional utterance;
obtain a portion of the second uttered voice corresponding to a certain range based on the second overlapping utterance as a second additional utterance; and
use the first additional utterance and the second additional utterance to generate the synthesized voice.

7. The electronic device of claim 1, wherein the processor is configured to:
receive information related to the second reproduction speed from the first external device or the second external device; and
convert the synthesized voice based on the received information.

8. The electronic device of claim 1, wherein the processor is configured to convert the synthesized voice such that a certain level of pitch is maintained for the first overlapping utterance and the second overlapping utterance.

9. A method for operating an electronic device, the method comprising:
receiving and storing a first uttered voice related to at least a first external device and a second uttered voice related to a second external device;
sensing a single utterance or simultaneous utterances based on the first uttered voice and the second uttered voice;
transmitting the first uttered voice or the second uttered voice having a first reproduction speed to at least the first external device and the second external device when the single utterance is sensed; and
converting a reproduction speed of at least a portion of a synthesized voice where at least a first overlapping utterance of the first uttered voice and at least a second overlapping utterance of the second uttered voice are continuously connected to each other to a second reproduction speed different from the first reproduction speed and transferring the synthesized voice to at least the first external device and the second external device when the simultaneous utterances are sensed.

10. The method of claim 9, wherein the first reproduction speed is a speed substantially equal to an utterance speed of a speaker, and the second reproduction speed includes a speed higher than the first reproduction speed.

11. The method of claim 9, further comprising:
identifying a first utterance time period related to the first overlapping utterance and a second utterance time period related to the second overlapping utterance; and
determining the second reproduction speed such that the synthesized voice is reproduced within a time period smaller than a sum of the first utterance time period and the second utterance time period.

12. The method of claim 9, further comprising:
converting a reproduction speed of at least one of at least a portion of the first overlapping utterance and at least a portion of the second overlapping utterance into the second reproduction speed.

13. The method of claim 9, further comprising:
generating the synthesized voice with a silence period added between the first overlapping utterance and the second overlapping utterance.

14. The method of claim 9, further comprising:
obtaining a portion of the first uttered voice corresponding to a certain range based on the first overlapping utterance as a first additional utterance;
obtaining a portion of the second uttered voice corresponding to a certain range based on the second overlapping utterance as a second additional utterance; and
using the first additional utterance and the second additional utterance to generate the synthesized voice.

15. The method of claim 10, further comprising:
converting the synthesized voice such that a certain level of pitch is maintained for the first overlapping utterance and the second overlapping utterance.

16. An electronic device operating method, comprising:
receiving and storing first and second uttered phrases from first and second external devices, respectively;
sensing simultaneous portions of the first and second uttered phrases;
generating a synthesized voice for combining the simultaneous portions; and
outputting the synthesized voice with a combination of the simultaneous portions to a user.

17. The method of claim 16, wherein the outputting comprises connecting the first and second uttered phrases.

18. The method of claim 16, wherein the outputting comprises connecting portions of the first uttered phrases with portions of the second uttered phrase.

19. The method of claim 16, wherein:
the outputting comprises executing natural language processing with respect to the first and second uttered phrases and modifying the first and second uttered phrases in accordance with results of the natural language processing,
the generating comprises generating the synthesized voice for combining the simultaneous portions as modified; and
the outputting further includes outputting the synthesized voice with a combination of the simultaneous portions as modified to a user.

20. The method of claim 16, further comprising delaying the outputting in accordance with user instructions.
